(19) United States
(12) Patent Application Publication
(10) Pub. No.: US 2014/0281596 A1
(43) Pub. Date: Sep. 18, 2014

(54) FREQUENCY ADJUSTMENT SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: SONG-LIN TONG, Shenzhen (CN); YUN BAI, Shenzhen (CN); XI-RONG PENG, Shenzhen (CN); PENG CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/207,415

(22) Filed: Mar. 12, 2014

(30) Foreign Application Priority Data
Mar. 12, 2013 (CN) 2013100779410

(51) Int. Cl. G06F 1/26

(52) U.S. Cl. CPC G06F 1/26
USPC 713/300

(57) ABSTRACT

A frequency adjustment system includes a phase-locked loop (PLL) circuit, an adjusting circuit, and a voltage regulator module (VRM). The PLL circuit outputs a trigger signal when a communication frequency of a chip changes. The adjusting circuit adjusts a clock frequency of the adjusting circuit to receive communication data. The adjusting circuit further outputs a control signal to the VRM. The VRM outputs a voltage according to the control signal.

### FIELD

The present disclosure relates to a frequency adjustment system, particularly to a frequency adjustment system for a central processing unit (CPU) chip.

### BACKGROUND

A voltage regulator module (VRM) communicates with a CPU chip through a power manager bus (PMBus), to perform certain functions, such as providing a proper voltage for the CPU chip. A communication frequency between the CPU chip and the VRM should be in synchronization. For example, if the communication frequency of the CPU chip is 25 million Hertz (MHz), but the communication frequency of the VRM should also be 25 MHz. However, the communication frequency of the CPU chip has great relationship with a clock rate of the CPU chip. In a case that the clock rate of the CPU chip changes, the communication rate of the CPU chip changes synchronously, the communication frequency of the VRM may not be changed fast enough. Thus, if the communication frequencies of the VRM and the CPU chip become inconsistent, the communication data between the CPU chip and the VRM may be lost or malfunction, the VRM may not provide the proper voltage to the CPU chip according to the communication data.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a first embodiment of a frequency adjustment system of the present disclosure, wherein the frequency adjustment system comprises an adjusting circuit.

FIG. 2 is a block diagram of the adjusting circuit of FIG. 1.

FIG. 3 is a block diagram of a second embodiment of the frequency adjustment system of the present disclosure.

FIG. 4 is a flow chart of an embodiment of a frequency adjustment method of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 illustrates a first embodiment of a frequency adjustment system of the present disclosure. The frequency adjustment system can comprise a central processing unit (CPU) chip 40, a voltage regulator module (VRM) 30, a phase-locked loop (PLL) circuit 50, and an adjusting circuit 60.

In the embodiment, the CPU chip 40 can output communication data to the VRM 30 through a power management bus (PMBus) 70. The communication data can comprise a plurality of control instructions. The VRM 30 can output a regulated voltage to the CPU chip 40 according to the control instructions from the CPU chip 40. The PMbus 70 can comprise a clock signal line SCL, a data signal line SDA, and an alert signal line ALTER.

The PLL circuit 50 can determine a clock rate of the CPU chip 40, and can generate a trigger signal to the adjusting circuit 60 on the condition that the clock rate of the CPU chip 40 changes.

FIG. 2 shows that the adjusting circuit 60 can comprise a microcontroller unit (MCU) 609 and a storage unit 608. The storage unit 608 can store a plurality of programs to be executed by the MCU 609, to perform certain functions. The storage unit 608 can comprise a receiving unit 600, an analyzing unit 602, an output unit 604, and an adjusting unit 606.

The receiving unit 600 can receive the trigger signal from the PLL circuit 50, to obtain the communication frequency of the CPU chip 40. The adjusting unit 606 can adjust a clock frequency of the adjusting circuit 60 according to the trigger signal, to comply with the communication frequency of the CPU chip 40. For example, when the communication rate of the CPU chip 40 is changed from 25 million hertz (MHz) to 41.67 MHz, the adjusting unit 606 adjusts the clock frequency of the MCU 609 to 41.67 MHz.

The analyzing unit 602 can obtain communication data between the CPU chip 40 and the VRM 30 with the adjusted clock frequency. The analyzing unit 602 can further analyze the communication data to obtain the control instructions. The output unit 604 can output a control signal with respect to the control instructions to the PWM controller 300 through a general purpose input output (GPIO) signal line 610.

The VRM 30 can comprise a pulse width modulation (PWM) controller 300. The PWM controller 300 can receive the control signal, and can provide a corresponding voltage for the CPU chip 40 according to the control signal. Accordingly, when the clock rate of the CPU chip 40 is changed, the VRM can still provide the proper voltage for the CPU chip 40.

FIG. 3 shows a second embodiment of the frequency adjustment system of the present disclosure. The adjusting circuit 60 can be integrated in the VRM 30.

FIG. 4 shows an embodiment of a frequency adjustment method of the present disclosure. The frequency adjustment method can comprise steps shown below.

In step S1, the PLL circuit 50 can determine whether the clock rate of the CPU chip 40 is changed. If the clock rate of the CPU chip 40 is changed, step S2 can be implemented. If the clock rate of the CPU chip 40 is unchanged, step S1 can be repeated.

In step S2, the PLL circuit 50 can output the trigger signal with respect to the communication frequency of the CPU chip 40.

In step S3, the adjusting circuit 60 can adjust the clock frequency according to the trigger signal.

In step S4, the adjusting circuit 60 can obtain control instruction according to the communication data outputted by the CPU chip 40.

In step S5, the adjusting circuit 60 can output the control signal with respect to the control instruction, and can output the control signal to the PWM controller 300 of the VRM 30.

In step S6, the PWM controller 300 can output a corresponding PWM signal, to provide a proper voltage for the CPU chip 40.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A frequency adjustment system, comprising:
a phase-locked loop (PLL) circuit detecting a communication frequency of a chip; wherein the PLL circuit outputs a trigger signal when the communication frequency of the chip is changed;
an adjusting circuit receiving the trigger signal from the PLL circuit, adjusting a clock frequency of the adjusting circuit, receiving communication data from the chip, and outputting a control signal with respect to the communication data; and
a voltage regulator module (VRM) comprising a pulse width modulation (PWM) controller, wherein the PWM controller receives the control signal from the adjusting circuit, and outputs a voltage according to the control signal.

2. The frequency adjustment system of claim 1, wherein the adjusting circuit comprises:
a microcontroller unit (MCU); and
a storage unit storing a plurality of programs to be executed by the MCU to perform certain functions, the storage unit comprising:
a receiving unit receiving the trigger signal from the PLL circuit;
an adjusting unit adjusting the clock frequency of the adjusting circuit;
an analyzing unit receiving the communication data according to the clock frequency, and obtaining a control instruction according to the communication data; and
an outputting unit outputting the control signal with respect to the control instruction to the PWM controller.

3. The frequency adjustment system of claim 2, wherein the adjusting circuit outputs the control signal to the VRM through a general purpose input output signal line.

4. The frequency adjustment system of claim 2, wherein the chip outputs the communication data to the adjusting circuit through a power management bus.

5. The frequency adjustment system of claim 2, wherein the chip is a central processing unit chip.

6. A frequency adjustment method, comprising:
determining whether a clock rate of a chip is changed by a phase-locked loop (PLL) circuit;
outputting a trigger signal to an adjusting circuit with respect to a communication frequency of the chip by the PLL circuit, in response to the clock rate of the chip being changed; wherein the communication frequency of the chip has relationship with the clock rate of the chip;
adjusting a clock frequency of the adjusting circuit according to the trigger signal by the adjusting circuit;
receiving communication data from the chip to obtain control instruction by the adjusting circuit;
outputting a control signal to a pulse width modulation (PWM) controller by the adjusting circuit; and
outputting voltage for the chip according to the control signal.

7. The frequency adjustment method of claim 6, wherein the adjusting circuit outputs the control signal to the VRM through a general purpose input output signal line.

8. The frequency adjustment method of claim 6, wherein the chip is a central processing unit chip.
